(19) United States
(12) Patent Application Publication
(10) Pub. No.: US 2007/0199518 A1
(43) Pub. Date: Aug. 30, 2007

(54) Apparatus for tented and protective relief station and method for use

(76) Inventor: Nancy C. Siemer, Alexandria, VA (US)

Correspondence Address: TOD R NISSLE, PO BOX 55630, PHOENIX, AZ, 85078, US

(21) Appl. No.: 11/643,345

(22) Filed: Dec. 21, 2006

Related U.S. Application Data
(60) Provisional application No. 60/753,692, filed on Dec. 22, 2005.

(51) Int. Cl. A01K 1/03

(52) U.S. Cl. 119/498

(57) ABSTRACT

An apparatus and method is provided to protect a dog from inclement weather and birds of prey or other animals while the dog relieves itself. The apparatus comprises a tent structure enclosed on integrated top and sides and front and rear, no floor structure providing the animal direct access to the open ground for relieving itself, flapped textile panel entry access at front and means for ventilation of odors and circulation of fresh air. In practicing the method, a tent is provided and erected out-of-doors. A dog is trained to utilize the tent. During inclement weather, the dog is placed outside to relieve itself in the tent.

This application claims priority based on U.S. provisional patent application Ser. No. 60/753,692, filed Dec. 22, 2005.

This invention relates to products for animals, particularly dogs.

More particularly, the invention relates to an apparatus and method and to facilitate a dog's relieving itself.

In another respect, the invention relates to an apparatus and method to reduce during inclement weather the risk that a dog will relieve itself in the residence of the dog's owner and the risk that the dog will aggravate an injury while relieving itself out-of-doors.

During inclement weather, many dogs are adverse to going out-of-doors to relieve themselves and often will, as a consequence, find a spot in the residence of the dog's owner to urinate or defecate.

Another problem associated with a dog being out-of-doors to relieve itself is that the dog is susceptible to attack by birds of prey or other animals. This is particularly the case with small dogs.

A further problem associated with a dog being out-of-doors to relieve itself during inclement weather is that the dog is wet and dirty when the dog returns inside.

Accordingly, it would be highly desirable to provide an apparatus and method to facilitate a dog's relieving itself during inclement weather and when birds of prey or other animals are in the vicinity.

Therefore, it is a principal object of the invention to provide an improved apparatus and method for a dog to relieve itself out-of-doors.

Another object of the invention is to provide an improved apparatus and method that makes a dog willing to travel out-of-doors during inclement weather to relieve itself.

A further object of the invention is to provide an improved apparatus and method that reduces the risk of attack by a bird of prey or other animal when a dog is in a vulnerable, generally stationary position while relieving itself.

Yet another object of the invention is to provide a structure that conceals animal fecal matter, while providing ventilation to relieve the structure of some or most odors resulting from said fecal matter.

These and other, further and more specific objects and advantages of the inventions will be apparent to those skilled in the art from the following detailed description thereof, taken in conjunction with the drawings, in which:

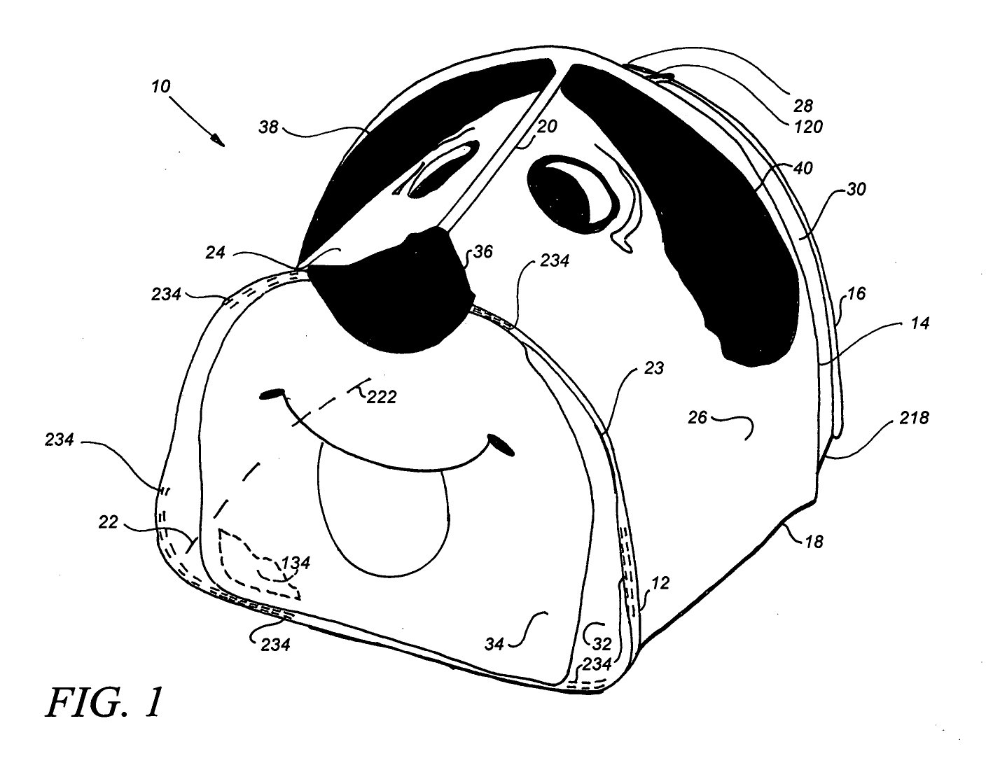

FIG. 1 is a perspective view illustrating tent apparatus constructed in accordance with the principles of the invention;

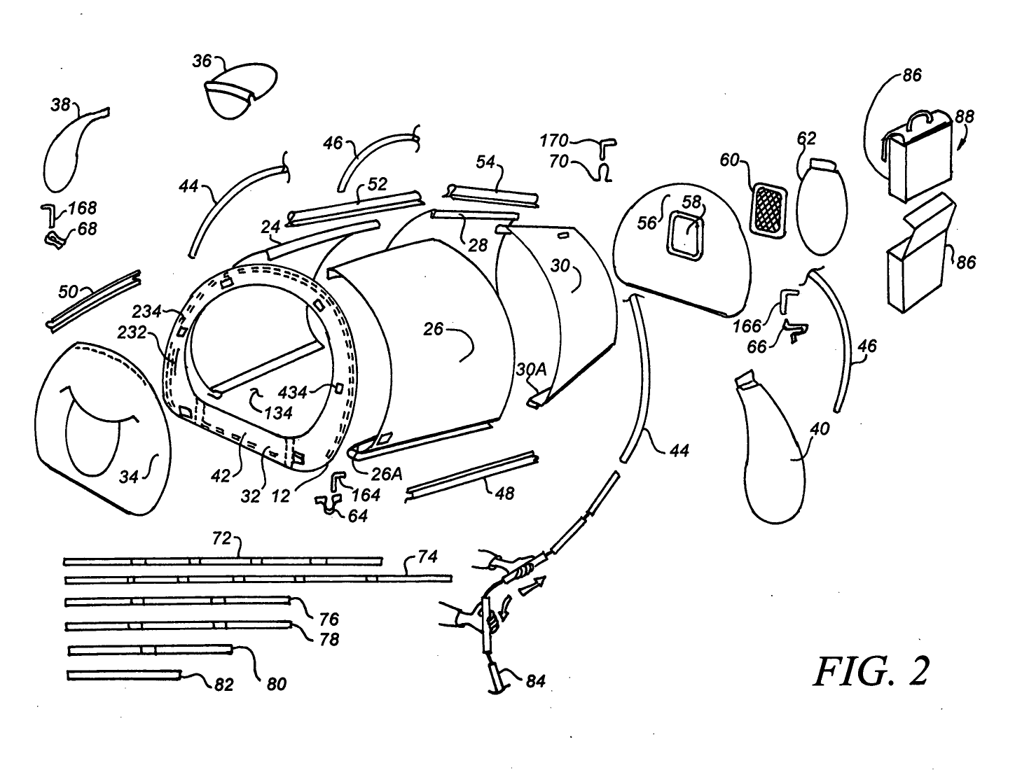

FIG. 2 is an exploded assembly view illustrating in greater detail structural components of the apparatus of FIG. 1;

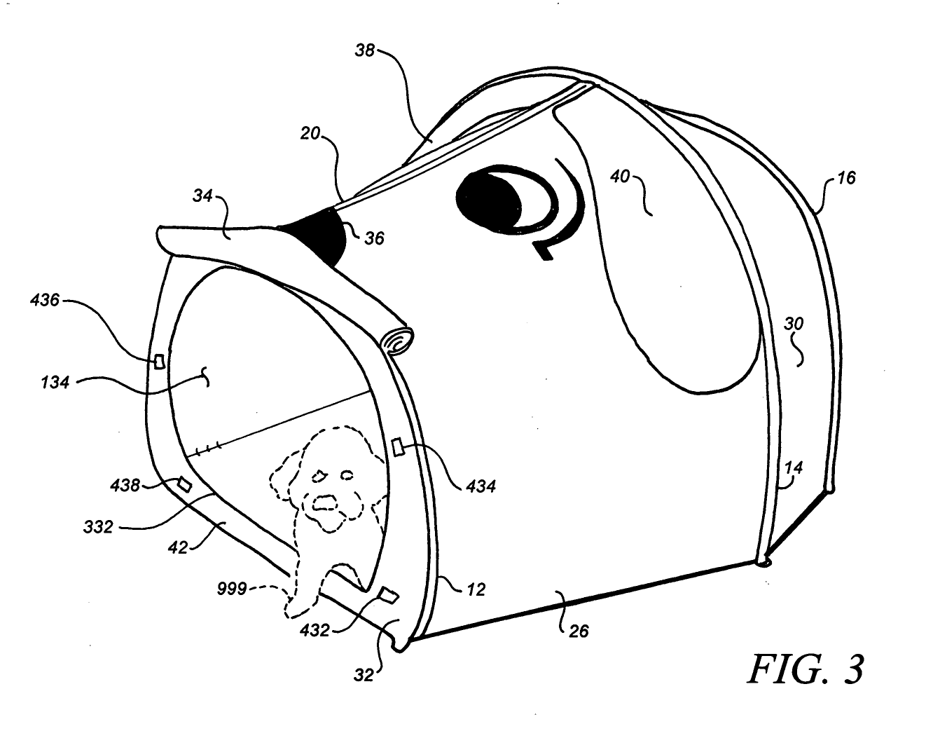

FIG. 3 is a perspective view of the tent apparatus of FIG. 1 illustrating the mode of operation thereof;

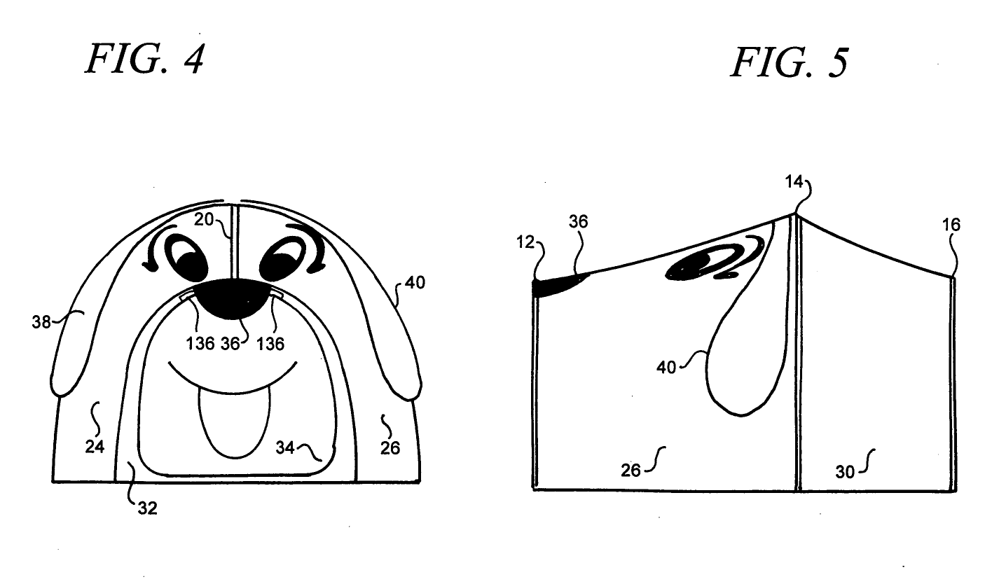

FIG. 4 is a front view illustrating the tent apparatus of FIG. 1 with the flap down;

FIG. 5 is a side view illustrating the tent apparatus of FIG. 1;

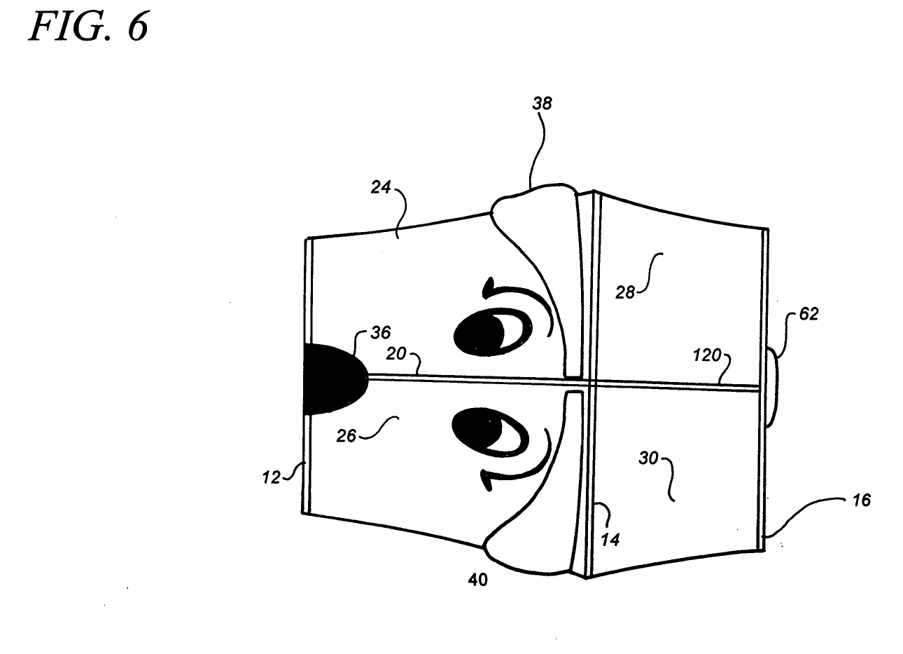

FIG. 6 is a top view illustrating the tent apparatus of FIG. 1;

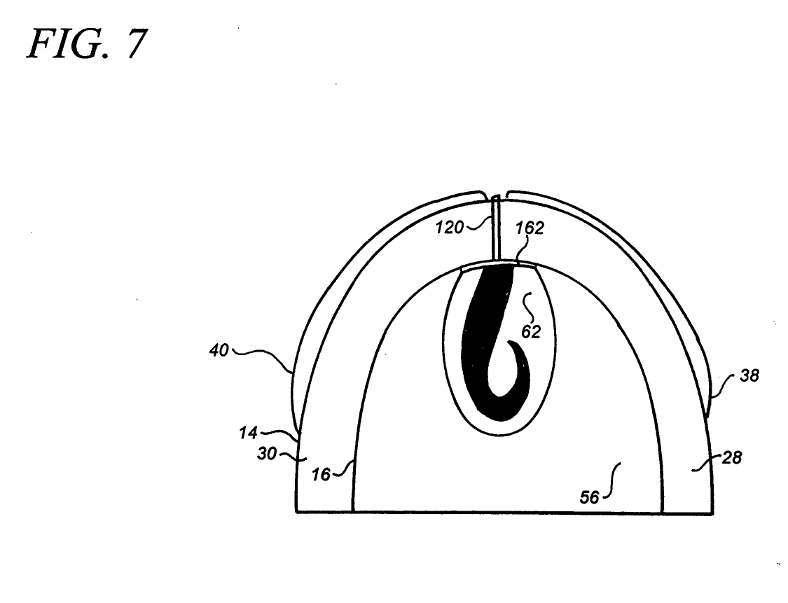

FIG. 7 is a rear view illustrating the tent apparatus of FIG. 1;

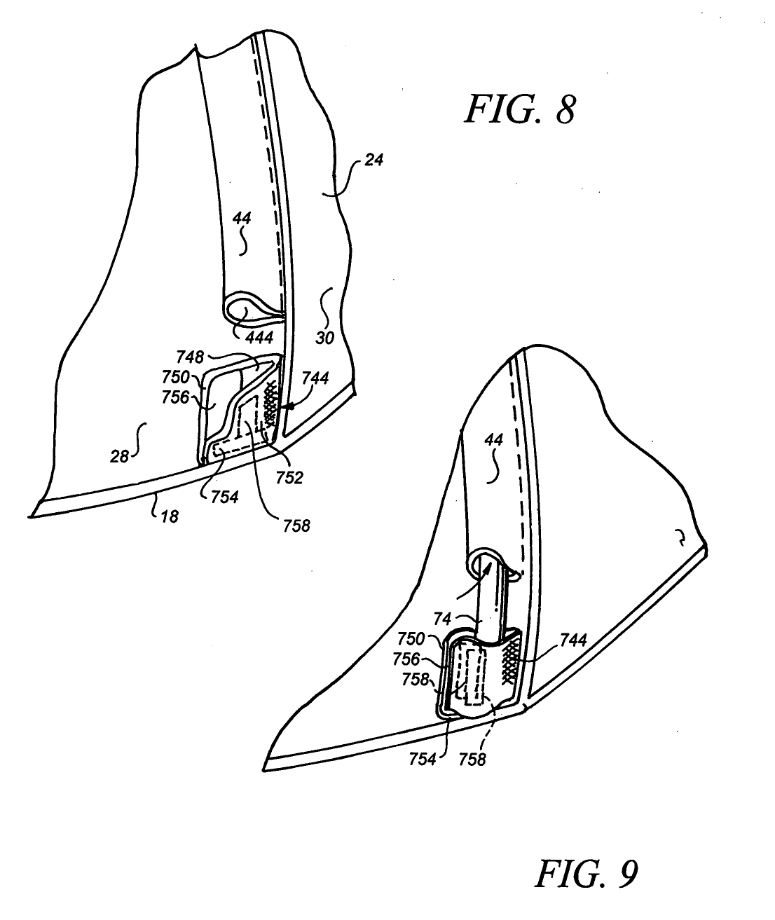

FIG. 8 is a perspective view illustrating a sleeve structure for pole insertion;

FIG. 9 is a perspective view illustrating a pole inserted and secured in the sleeve structure of FIG. 8;

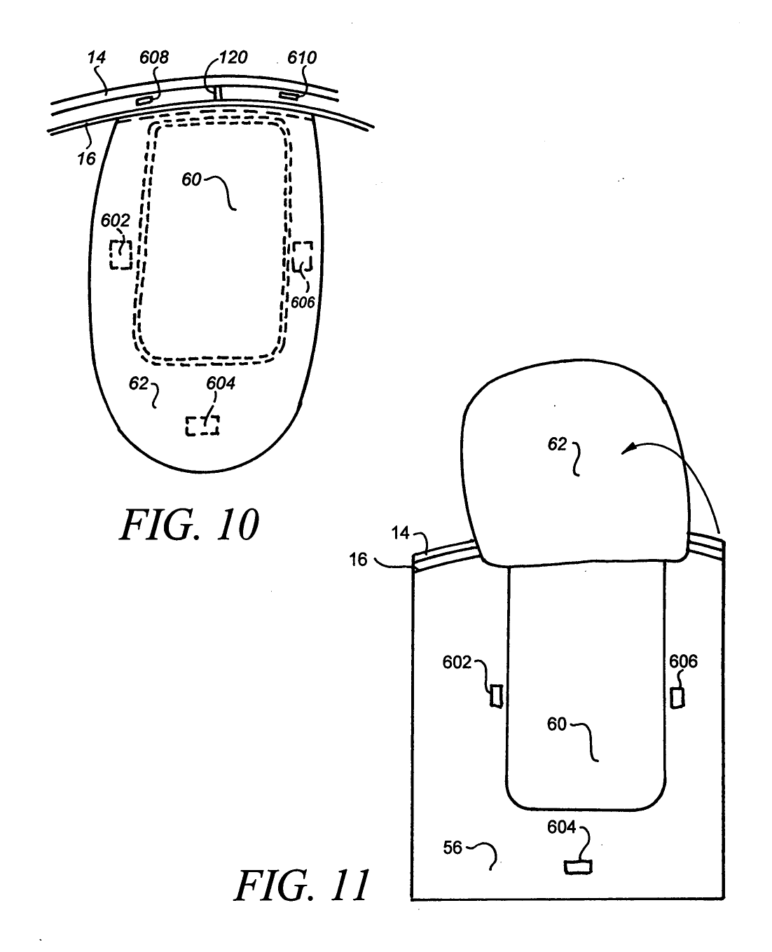

FIG. 10 is a rear view of the tent apparatus of FIG. 1 illustrating the tail flap in the stowed position and covering the rear mesh vent window;

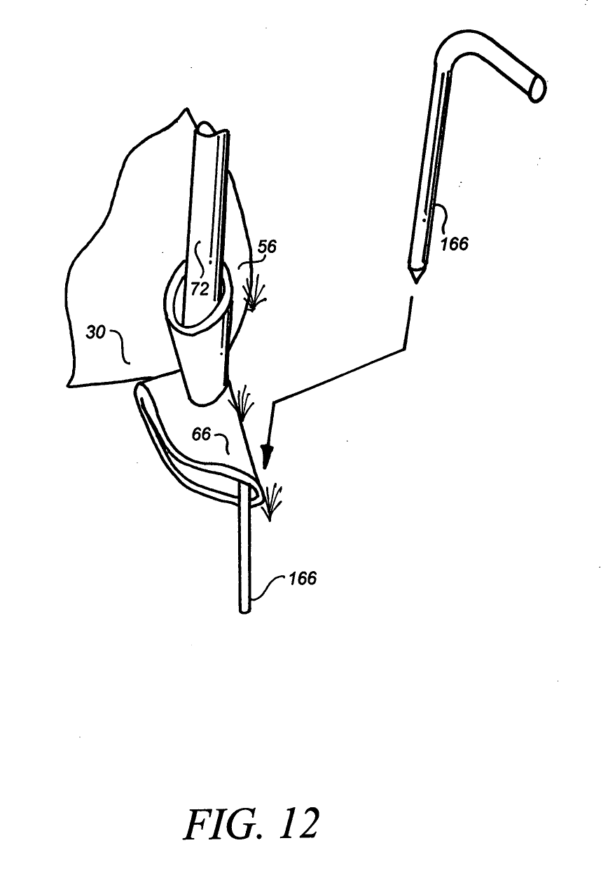

FIG. 11 is a rear view of the tent apparatus of FIG. 1 illustrating the tail flap opened and exposing the rear mesh vent window; and,

FIG. 12 is a perspective view of the tent apparatus of FIG. 1 illustrating one of the corners of the apparatus staked.

Briefly, in accordance with my invention, I provide an improved apparatus for allowing a dog to relieve itself outdoors comprising a protective tent enclosure. The tent enclosure includes a top and sides, and front and a rear, with vents to permit outside ambient air to move into said tent enclosure, and is shaped and dimensioned to enclose an area of open ground for the dog to relieve itself while inside the tent enclosure. The enclosure can further comprise a textile panel flap to provide the dog access into and out of the apparatus without human assistance, and can comprise an exterior configured to dissuade birds of prey or other animals from hunting in area adjacent the tent structure. The textile flap can have a first operative position in which the flap is stretched and secured and prevented from being opened, and a second operative position in which the flap is released, is contracted, and can be displaced by a dog to permit the dog to enter the tent enclosure.

In another embodiment of the invention, I provide an improved method for protecting a dog from inclement weather while the dog is relieving itself. The method includes the steps of providing a tent sized to receive the dog; erecting the tent on the ground out-of-doors; letting the dog out-of-doors; training the dog to relieve itself on the open ground inside the tent; and, letting the dog out-of-doors during inclement weather to relieve itself on the ground in the tent. The tent can also include an exterior configured to dissuade birds of prey or other animals from hunting in area adjacent the tent structure. The tent can include an entry flap having a first operative position in which the flap is stretched and secured and prevented from being opened, and a second operative position in which the flap is released, is contracted, and can be displaced by a dog to permit the dog to enter the tent.

In a further embodiment of the invention, I provide an improved method of protecting a dog from birds of prey or other animals while the dog is relieving itself. The method comprises the steps of providing a tent sized to receive the dog and having an exterior configured to dissuade birds of prey or other animals from hunting in an area adjacent the tent; erecting the tent on the ground out-of-doors; letting the dog out-of-doors; training the dog to relieve itself on the open ground inside the tent; letting the dog out-of-doors during inclement weather to relieve itself on the ground in the tent. The tent can includes an entry flap that has a first operative position in which the flap is stretched and secured and prevented from being opened, and a second operative position in which the flap is released, is contracted, hangs loosely, and can be displaced by a dog to permit the dog to enter the tent.

Turning now to the drawings, which depict the invention for purposes of explanation and not by way of limitation of the invention, and in which like reference characters refer to corresponding elements throughout the several views, FIG. 1 illustrates a tent constructed in accordance with the principles of the invention and generally indicated by reference character 10.

Tent 10 includes three spaced apart, substantially parallel ribs 12, 14, 16 which can be constructed in any desired manner. Rib 12 presently includes a flat spring steel form 234 inserted in fabric sleeve 232. Sleeve 232 is sewn to fabric front panel 32, fabric roof panel 24, and fabric roof panel 26. Ribs 14 and 16 each include sectioned, collapsible elastic corded poles (or continuous length fiberglass poles) inserted in a fabric sleeve. The tops of ribs 12 and 14 are interconnected by member 20. The tops of ribs 14 and 16 are interconnected by member 120. Members 20 and 120 each include sectioned, collapsible elastic corded poles inserted in a fabric sleeve. Fabric roof panels 24 and 26 are, in addition to being sewn to rib 12, sewn to rib 14 and member 20. Fabric roof panels 28 and 30 are sewn to ribs 14 and 16 and to member 120. Rear fabric panel 56 is sewn to rib 16. Fabric flap door panel 34 is attached to rib 12 by hinge or seam 136 (FIG. 4) extending along the top of panel 34. Fabric tail panel 62 is attached to rib 16 by hinge or seam 162 (FIG. 7) extending along the top of panel 62.

Panels 24, 26, 28, 30, 32, 34, 56, 62 can be made from any desired material, but presently preferably comprise light-weight waterproof or water-resistant fabric(s). Such fabric can, for example, comprise nylon or polyester and can be treated with chemical or lined with another fabric or material to improve water resistance.

Door panel 34 covers opening 134 in front panel 32. Panel 34 is shaped and constructed such that a dog can move or push panel 34 to enter and leave tent 10. After panel 34 is moved by a dog, and the dog is completely inside tent 10 or has completely exited tent 10 through opening 134, panel 34 normally falls or moves back into a position in which panel 34 substantially or completely covers opening 134. If a dog will not be utilizing the tent 10 for an extended period of time, VELCO® fastening tabs 432, 434, 436, 438 (FIGS. 2, 3) can be secured to panel 32 and/or 34 to more securely, but removably, fasten panel 34 in place over opening 134.

FIG. 1 depicts decorative portions on tent 10 that make tent 10 appear like the head of a dog. These decorative portions include felt nose 24, and ears 38, 40 which may, if desired, be attached to tent panels with VELCO® fasteners. Nose 24 can, if desired, function as an attachment point for VELCO® fasteners on panel 34 when panel 34 is in the stowed position illustrated in FIG. 3.

The decorative portions on tent 10 also include a mouth and tongue screened or printed on the front flap door 34 and eyes screened or printed on panels 24 and 26; and other textile fabrications to represent nose, ears and tail, which provide VELCO® attachment or concealment of mesh ventilation windows respectively. Decorating or manufacturing or otherwise configuring tent 10 to look like the head of a large dog is believed important because when viewed at a distance by a bird of prey or other animal, the exterior appearance of tent 10 may, at least initially, dissuade a bird of prey or other animal from considering to attack or hunt in the area in which the tent is erected. Any configuration of tent 10 that will tend to dissuade a bird of prey or other animals from considering to attack or hunt in the area in which the tent is erected can be utilized. Tent 10 can be made to look like a coyote, can include flashing lights, can include reflectors, can include odors that are disagreeable to a bird of prey or other animal, can include apparatus for producing sounds that are disagreeable to a bird of prey or other animal, etc. Configuring tent 10 to discourage predators is an important feature of the invention because nearly every area of the world has predators that can pose a danger to a dog.

In FIG. 2, panel 32 includes bottom portion 34. Rib 12 comprises a pre-assembled flat spring steel rod inserted in sleeve 232. Collapsible elastic corded pole 74 is inserted in sleeve 44 to form rib 14. Panels 24, 26, 28, 30 each include feet or “returns” 26A, 30A that project inwardly three to four inches to provide an additional barrier against water incursion. Rib 16 comprises a collapsible elastic-corded pole 72 slidably inserted and secured in sleeve 46. Member 20 comprises collapsible elastic-corded pole 80 slidably inserted and secured in sleeve 52. Member 120 comprises collapsible elastic-corded pole 82 slidably inserted and secured in sleeve 54.

Rear panel 56 includes opening 58 and mesh rear window 60 that is sewn over opening 58. Tail panel 62 normally covers opening 58 and window 60. The ground-engaging bottom portions 18, 22, 218, 222 of panels 26, 24, 30, 28 (FIG. 1) can, if desired, be strengthened with additional rib components comprising, for example, fabric sleeves 48, 50 with collapsible elastic-corded poles 76 and 78 (FIG. 2) inserted therein. In FIG. 2, reference character 84 illustrates a collapsible elastic corded pole 74 being slidably snaked into fabric sleeve 44. Such poles 74 are commonly found in tent structures and include an elastic cord that runs through the pole segments, that is attached to each end of the pole, and that functions to pull together all of the segments in the pole.

In FIG. 2, corners loops 64, 66, 68 and 70 are each sewn at a different one of the four corners of tent 10. Stakes 164, 166, 168, 170 are driven through loops 64, 66, 68, 70, respectively, to secure tent 10 to the ground. Tent 10 is inserted and stored in carry bag 86. Bag 86 is illustrated in FIG. 2 in an open and closed configuration.

FIG. 3 illustrates a small dog 999 exiting tent 10 through opening 134. Tent 10 extends over the open ground 332 that is circumscribed by tent 10 and covered by the various roof panels 24, 26, 28, 30. Dog 999 can urinate or defecate on the open ground 332, after which the dog's owner typically periodically removes the feces. In alternate embodiment, if desired, a piece of material (not shown) can be provided to cover the ground. The dog 999 can relieve itself on the material. The material is preferably, but not necessarily, pliable, absorbent, and disposable.

The shape and dimension of ribs 12, 14, 16, and members 20 and 120 can, as noted, vary as desired. The presently preferred portions of said ribs are, however, depicted in FIG. 5, with rib 14 being approximately thirty percent higher than ribs 12 and 16, and with the distance between ribs 14 and 16 being approximately fifty percent shorter than the distance between ribs 12 and 14. The taller rib 14 facilitates shedding of rain by tent 10.

In FIG. 6, the width of rib 14 is approximately 25% greater than the width of ribs 12 and 16 to facilitate the movement of a dog 999 in tent 10.

When tail 62 is in the position illustrated in FIG. 7, it covers and prevents rain from entering mesh window 60, but hangs loosely enough to permit air to flow through window 60. Tail 62 can, if desired, be lifted up and over the top of tent 10 and secured in position with VELCO® fasteners on tail 62 or the top of tent 10.

FIG. 8 illustrates sleeve 44 sewn to panel 28. Sleeve 44 includes open end 444. Closure structure 744 receives one end of a pole 74 that extends through sleeve 44 and out from end 444. Structure 744 is made of fabric webbing, but can be constructed from any desired material. Structure 744 includes an interior member 748 sewn to panel 28 along its periphery 750, and includes an exterior member 752 opposed to member 748 and sewn to panel 28 and member 748 only along its bottom edge 754. Male VELCO® fastener 756 is secured to the face of interior member 748, and an opposing female VELCO® fastener 758 is secured to the member 752. Once the end of a pole 744 is inserted between members 748 and 752 in the manner illustrated in FIG. 9, fasteners 750 and 758 are pressed together to secure the end of pole 744 therebetween. When pole 744 is being removed from structure 744, member 752 and fastener 758 can be pulled apart from member 748 and fastener 756.

FIGS. 10 and 11 illustrate VELCO® fasteners 602, 602, 606 used to secure tail panel 62 in position over window 60, and illustrate VELCO® fasteners 608, 610 (FIG. 10) that can be used to secure tail 61 to the top of tent 10 when tail is lifted upwardly away from window 60 and onto the top of tent 10. Tail panel 62 is preferably shaped and dimensioned to appear like the tail of a dog, or has a drawing or other art work on panel 62 that looks like the tail of a dog. When tail panel 62 is opened and fully exposes window 60 in the manner illustrated in FIG. 11, and when door panel 34 is opened, the cross-ventilation in tent 10 is maximized. To improve the ventilation of tent 10, other windows can, if desired, be formed in tent 10.

FIG. 12 illustrates an L-shaped tent stake 166 utilized in conjunction with a corner stake loop 66 to secure tent 10 at a selected location on the ground. One leg of stake 166 is driven into the ground. The other leg engages loop 66. Similar stakes can be utilized in conjunction with loops 64, 68, 70 to secure tent to the ground.

In use, a tent 10 is provided. The tent is sized to permit a dog of a selected size to enter the tent and to maneuver in the tent to relieve itself. The tent is erected out-of-doors, typically in the back yard of a building or adjacent a building where the dog resides. The building can be a commercial building or doghouse or any other building, but usually comprises a residence. The tent 10 has an opening 134 and/or door 34 that permits a dog to enter and exit the tent, typically without assistance from the dog's owner.

Although as noted in an alternative embodiment (not shown) a disposable (or permanent) floor can, if desired, be provided for tent 10, in the preferred embodiment tent 10 does not have a floor. Instead, the “floor” of the tent comprises the open ground on which the tent is erected. Reasons for not providing tent 10 with a floor are discussed in more detail below.

If appropriate, the tent can be erected on the open ground at a location that is next to, adjacent, or close to a covered porch or other portion of the building such that a dog can step directly from the porch into the tent or such that the dog has only a short distance to go before reaching the tent. This makes use of the tent particularly convenient for a dog during inclement weather, if the dog has an injured bandaged leg, or when birds of prey or other animals are in the vicinity. The close proximity of the tent to the building also avoids or minimizes the dog becoming wet or muddy during rainy inclement weather.

The dog is trained to utilize tent 10. This training can be accomplished in any desired manner, but one common way of training the dog is to place an object inside the tent that includes the odor of the dog's urine or feces, or the dog's own fecal matter, and to then place the dog inside the tent to smell the odor. In many cases, the dog immediately recognizes the purpose of the tent. The tent 10 is in fact deliberately designed so that the dog continues to relieve itself on open ground, as it has been trained to do early in life—and not on artificial floors, which is the case in many prior art outdoor pet structures. In fact, the instant invention proceeds from the premise that introducing an artificial floor into an outdoor relief structure for a dog tends to confuse the animal as to the appropriate location for relieving itself. That is, if the floor of the outdoor relief structure is similar to the floors of the home's interior, the dog's sense of “appropriate location” for relieving itself may be seriously and negatively affected. Further, if the tent 10 has a floor, the dog may associate the tent with the dog owner's residence and assume that if it is permitted to relieve itself on the floor in the tent, it may be acceptable to relieve itself on the floor in the dog owner's residence. Another disadvantage of having a floor in tent 10 is that floor 10 tends to absorb disagreeable odors associated with a dog's waste. Removing such odors from the floor can be difficult. In contrast, the ground tends to absorb and carry away and nullify such odors. Since periodic removal of the animal's waste debris is required, clean up is as simple as moving the tent.

During inclement weather, the dog is put out-of-doors to relieve itself. The panel 34 loosely hangs down (or can be open) so that the dog pushes panel 34 open with its nose or paw and walks into tent 10. After the dog relieves itself on the ground inside the tent, the dog pushes flap open and exits the tent. The dog is let back in doors. Inclement weather can comprise rain, snow, sleet, unusually cold weather, or unusually warm weather. During unusually cold weather, tent 10 provides protection from wind and the inside of tent 10 normally will be warmer than the outside ambient temperature. During unusually warm weather, tent 10 provides shade from the sun and the inside of the tent will usually be cooler than the outside ambient temperature, particularly if panel 34 and tail panel 62 are each open so that cross ventilation in the tent 10 through window 60 and opening 134 is maximized.

An advantage of the design for panel 34 is that, unlike other entry means described in the prior art, panel 34 is designed as a sewn, flapped entry door, that opens and closes by means of the dog pushing in or out against it. Sufficient top and rear ventilation allows this door to remain loosely closed (although some ventilation does occur in this “loosely closed” state); for the owner, the advantage of this is that animal fecal matter remains concealed, yet the dog is allowed to enter and exit the tent without assistance or intervention from humans.

Another important feature of tent 10 concerns the use of VELCO® fasteners 432, 434, 436, magnets, or other closure devices that tend to “catch” and hold panel 34 is place against panel 32. In order for a dog to be able to ingress and egress tent 10 when panel 34 is hanging down in the general manner illustrated in FIG. 4, it is important that panel 34 be hang freely, be detached, and be readily displaced by the nose or foot of a dog attempting to enter to leave tent 10. In order to accomplish, the panel 34 is preferably made of a material that is stretched to a certain extent in order to secure peripheral portions of panel 34 to fasteners 432, 434, 436. When panel 34 is detached from fasteners 432, 434, 436, it resiliently contracts or changes shape sufficiently so that when panel 34 hangs freely it does not “catch” on fasteners 432, 434, 436, but it instead hangs loosely and can be readily moved by a dog entering or leaving tent 10. When it is later necessary to close panel 34, panel 34 is stretched such that it will engage and by secured by fasteners 432, 434, 436. One example of where a “stretch” and “contract” panel 34 can be utilized occurs when spaced apart opposing VELCO® fasteners are attached to the back of panel 34 and, when panel 34 is closed, each are in registration with and contact one of fasteners 432, 434, 436 when panel 34 is closed. After panel 34 is opened and contracts, the opposing VELCO® fasteners on the back of panel 34 are no longer in registration with fasteners 432, 434, 435, and, panel 34 hangs freely, fasteners 432, 434, 435 are not engaged by opposing fasteners on panel 34, and panel 34 can be easily moved by a dog entering and leaving tent 10.

Having described my invention in such terms as to enable those of skill in the art to understand and practice the invention, and having described the presently preferred embodiments thereof, I Claim:

1. An apparatus for allowing a dog to relieve itself outdoors comprising a tent enclosure comprising
(a) an integrated top and sides,
(b) a front and a rear, and
(c) vents to permit outside ambient air to move into said tent enclosure,
said enclosure shaped and dimensioned to enclose an area of open ground for the dog to relieve itself while inside said enclosure.

2. The apparatus as defined in claim 1, further comprising a textile panel flap to provide the dog access into and out of said enclosure without human assistance.

3. The apparatus as defined in claim 1 wherein said tent enclosure includes an exterior configured to dissuade birds of prey or other animals from hunting in an area adjacent said tent enclosure.

4. A method for protecting a dog from inclement weather while the dog is relieving itself, comprising the steps of
(a) providing a tent sized to receive the dog;
(b) erecting said tent on the ground out-of-doors;
(c) letting the dog out-of-doors;
(d) training the dog to relieve itself on the open ground inside said tent;
(e) letting the dog out-of-doors during inclement weather to relieve itself on the ground in said tent.

5. The method of claim 4 wherein said tent includes an exterior configured to dissuade birds of prey or other animals from hunting in area adjacent the tent structure.

6. A method for protecting a dog from birds of prey or other animals while the dog is relieving itself, comprising the steps of
(a) providing a tent sized to receive the dog and having an exterior configured to dissuade birds of prey from hunting in an area adjacent said tent;
(b) erecting said tent on the ground out-of-doors;
(c) letting the dog out-of-doors;
(d) training the dog to relieve itself on the open groun inside said tent;
(e) letting the dog out-of-doors during inclement weather to relieve itself on the ground in said tent.

7. The method of claim 6 wherein said tent includes an entry flap having
(a) a first operative position in which said flap is stretched and secured and prevented from being opened, and
(b) a second operative position in which said flap is released, is contracted, hangs loosely, and can be displaced by a dog to permit the dog to enter the tent.

8. The method of claim 4 wherein said tent includes an entry flap having
(a) a first operative position in which said flap is stretched and secured and prevented from being opened, and
(b) a second operative position in which said flap is released, is contracted, and can be displaced by a dog to permit the dog to enter the tent.

9. The apparatus of claim 1 wherein said tent enclosure includes an entry flap having
(a) a first operative position in which said flap is stretched and secured and prevented from being opened, and
(b) a second operative position in which said flap is released, is contracted, and can be displaced by a dog to permit the dog to enter said tent enclosure.
